(19) United States
(12) Patent Application Publication
(10) Pub. No.: US 2011/0280133 A1
(43) Pub. Date: Nov. 17, 2011

(54) SCALABLE SCHEDULER ARCHITECTURE FOR CHANNEL DECODING

(75) Inventors: Wei-Hsin Chang, San Diego, CA (US); Hanfang Pan, San Diego, CA (US); Michael Alexander Howard, San Diego, CA (US); Wenqing Wu, San Diego, CA (US)

(73) Assignee: QUALCOMM INCORPORATED, San Diego, CA (US)

(21) Appl. No.: 13/104,844

(22) Filed: May 10, 2011

Related U.S. Application Data
(60) Provisional application No. 61/333,649, filed on May 11, 2010.

(51) Int. Cl. H04W 72/04; H04W 24/00

(52) U.S. Cl. 370/241; 370/335

(57) ABSTRACT

Certain aspects of the present disclosure relate to a method for processing wireless communications. According to one aspect, a processing unit may receive a plurality of code blocks of a transport block and schedule the plurality of code blocks to be decoded in parallel with a plurality of decoders. Each decoder decodes at least one code block as an independent tasks. The processing unit further collects the decoded information bits from the plurality of decoders and forwards the collected decoded information bits for further processing. In one aspect, the processing unit includes an output agent to temporarily store the decoded information bits while waiting for all code blocks of the transport block to be decoded.

### CLAIM OF PRIORITY UNDER 35 U.S.C. §119

The present Application for Patent claims benefit of Provisional Application Ser. No. 61/333,649, entitled, “SCALABLE SCHEDULER ARCHITECTURE FOR CHANNEL DECODING, filed May 11, 2010, and assigned to the assignee hereof and hereby expressly incorporated by reference herein

### BACKGROUND

1. Field

Certain aspects of the present disclosure generally relate to wireless communications.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3^{rd} Generation Partnership Project (3GPP) Long Term Evolution (LTE) systems, and Orthogonal Frequency Division Multiple Access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in single-out (SISO), multiple-in single-out (MISO) or a multiple-in multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

### SUMMARY

Certain aspects of the present disclosure provide a method for wireless communications. The method generally includes receiving a plurality of code blocks of a transport block, scheduling the plurality of code blocks to be decoded in parallel with a plurality of decoders, each decoder decoding at least one code block as an independent task, collecting, from the plurality of decoders, decoded information bits from the code blocks, and forwarding the collected decoded information bits for further processing.

Certain aspects of the present disclosure provide an apparatus for wireless communications. The apparatus generally includes logic for receiving a plurality of code blocks of a transport block, logic for scheduling the plurality of code blocks to be decoded in parallel with a plurality of decoders, each decoder decoding at least one code block as an independent task, logic for collecting, from the plurality of decoders, decoded information bits from the code blocks, and logic for forwarding the collected decoded information bits for further processing.

Certain aspects of the present disclosure provide an apparatus for wireless communications. The apparatus generally includes means for receiving a plurality of code blocks of a transport block, means for scheduling the plurality of code blocks to be decoded in parallel with a plurality of decoders, each decoder decoding at least one code block as an independent task, means for collecting, from the plurality of decoders, decoded information bits from the code blocks, and means for forwarding the collected decoded information bits for further processing.

Certain aspects provide a computer-program product for wireless communications, comprising a computer readable medium having instructions stored thereon, the instructions being executable by one or more processors. The instructions generally include instructions for receiving a plurality of code blocks of a transport block, instructions for scheduling the plurality of code blocks to be decoded in parallel with a plurality of decoders, each decoder decoding at least one code block as an independent task, instructions for collecting, from the plurality of decoders, decoded information bits from the code blocks, and instructions for forwarding the collected decoded information bits for further processing.

Certain aspects provide an apparatus for wireless communications. The apparatus generally includes at least one processor configured to receive a plurality of code blocks of a transport block, schedule the plurality of code blocks to be decoded in parallel with a plurality of decoders, each decoder decoding at least one code block as an independent task, collect, from the plurality of decoders, decoded information bits from the code blocks, and forward the collected decoded information bits for further processing; and a memory coupled to the at least one processor.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example multiple access wireless communication system in accordance with certain aspects of the present disclosure.

FIG. 2 illustrates a block diagram of an access point and a user terminal in accordance with certain aspects of the present disclosure.

FIG. 3 illustrates various components that may be utilized in a wireless device in accordance with certain aspects of the present disclosure.

FIG. 4 illustrates an example of a sequential completion of code blocks in accordance with certain aspects of the present disclosure.

FIG. 5 illustrates an example of an out-of-order completion of code blocks in accordance with certain aspects of the present disclosure.

FIG. 6 illustrates a schematic block diagram of a turbo decoder scheduler in accordance with certain aspects of the present disclosure.

FIG. 7 illustrates an example operation that may be performed by a code block factory in accordance with certain aspects of the present disclosure.

FIG. 8 illustrates an example of a turbo decoder stall resulting from an out-of-order completion of code blocks in accordance with certain aspects of the present disclosure.

FIG. 9 illustrates an example of utilizing an output agent to reduce stalling of a turbo decoder in accordance with certain aspects of the present disclosure.

FIG. 10 illustrates an example operation that may be performed by a turbo decoder scheduler in accordance with certain aspects of the present disclosure.

FIG. 10A illustrates an apparatus that may be configured to perform decoding operations in accordance with certain aspects of the present disclosure.

### DETAILED DESCRIPTION

Typically, the processing power of multiple channel decoders is utilized to handle the high throughput requirement of wireless communication standards, such as LTE. Due to the different throughput requirements of various wireless applications, the number of channel decoders required at a given time may vary. Additionally, because channel decoding itself is not a linear process, a channel decoding process that starts late may finish earlier than previous decoding processes. This may result in an out-of-order condition should the decoded information from different channel decoders need to be assembled before sending to output. In such an out-of-order scenario, a channel decoder responsible for the last decoding task may need to wait, or stall, until all previous decoding tasks are completed. This behavior may lead to reduced utilization and degraded efficiency of decoding resources.

Accordingly, certain aspects of the present disclosure provide a channel decoder scheduler architecture configured to manage operations of and improve the efficiency of multiple channel decoders. According to certain aspects, a channel decoder scheduler may be configured to utilize a variable number of channel decoders. According to certain aspects, the channel decoder scheduler may be configured to break dependencies of neighboring decoding tasks, dispatch the decoding tasks to each available channel decoder independently, and collect the decoded output data of each channel decoder in a sequence suitable for assembly.

According to certain aspects, a centralized resource manager may be utilized to record the information of all available hardware resources utilized for decoding, including a channel interleaver, channel decoders, and decoder output buffers, and receive and dispatch decoding tasks as described further below. According to certain aspects, an intelligent arbitration and scheduling algorithm may utilized to dispatch decoding tasks according to the variable number of available channel decoders. According to certain aspects, an output agent may be utilized to process decoded information from a channel decoder such that the channel decoder may begin to process a next decoding task without having to stall.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2).

Single carrier frequency division multiple access (SC-FDMA) is a transmission technique that utilizes single carrier modulation at a transmitter side and frequency domain equalization at a receiver side. The SC-FDMA has similar performance and essentially the same overall complexity as those of OFDMA system. However, SC-FDMA signal has lower peak-to-average power ratio (PAPR) because of its inherent single carrier structure. The SC-FDMA has drawn great attention, especially in the uplink communications where lower PAPR greatly benefits the mobile terminal in terms of transmit power efficiency. It is currently a working assumption for uplink multiple access scheme in the 3GPP LTE and the Evolved UTRA.

An access point (“AP”) may comprise, be implemented as, or known as NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as an access terminal, a subscriber station, a subscriber unit, a mobile station, a remote station, a remote terminal, a user terminal, a user agent, a user device, user equipment, a user station, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects the node is a wireless node. Such wireless node may provide, for example, connectivity for or to a network (e.g., a wide area network such as the Internet or a cellular network) via a wired or wireless communication link.

Referring to FIG. 1, a multiple access wireless communication system according to one aspect is illustrated. An access point 100 (AP) may include multiple antenna groups, one group including antennas 104 and 106, another group including antennas 108 and 110, and an additional group including antennas 112 and 114. In FIG. 1, only two antennas are shown for each antenna group, however, more or fewer antennas may be utilized for each antenna group. Access terminal 116 (AT) may be in communication with antennas 112 and 114, where antennas 112 and 114 transmit information to access terminal 116 over forward link 120 and receive information from access terminal 116 over reverse link 118. Access terminal 122 may be in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In one aspect of the present disclosure each antenna group may be designed to communicate to access terminals in a sector of the areas covered by access point 100.

In communication over forward links 120 and 126, the transmitting antennas of access point 100 may utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

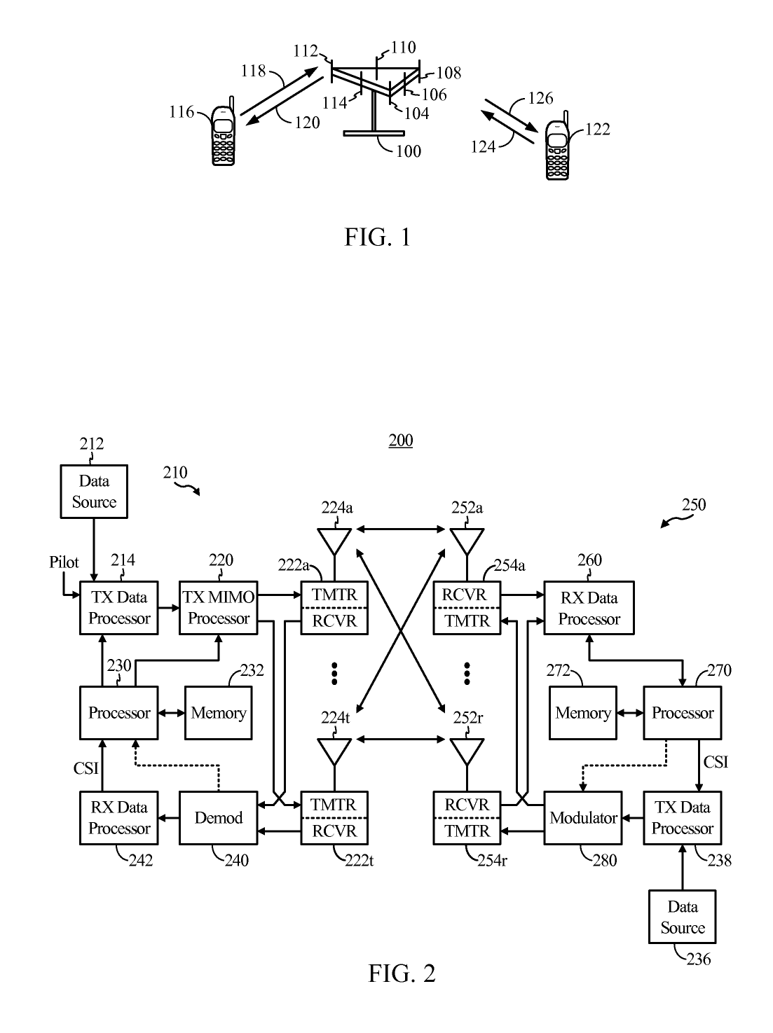

FIG. 2 illustrates a block diagram of an aspect of a transmitter system 210 (also known as the access point) and a receiver system 250 (also known as the access terminal) in a MIMO system 200. At the transmitter system 210, traffic data for a number of data streams is provided from a data source 212 to a transmit (TX) data processor 214.

In an aspect, each data stream may be transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects of the present disclosure, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals may be received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and further process the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 may be complementary to that performed by TX MIMO processor 220 and TX data processor 214 at transmitter system 210.

According to certain aspects, the RX processor 242 and RX processor 260 may be configured to utilize a scalable scheduler architecture to process a symbol stream as described herein. According to certain aspects, the RX processors 242, 260 may include a deinterleaver, a plurality of turbo decoders, and a turbo decoder scheduler. The deinterleaver breaks up the detected symbol stream into code blocks, which are then decoded by the turbo decoders. The turbo decoder scheduler centrally manages the plurality of turbo decoders to speed up turbo decoding and permit parallel processing. The turbo decoder scheduler may monitor all available hardware resources in a centralized scoreboard, including the deinterleaver and the plurality of turbo decoders. The turbo decoder scheduler may utilize an arbitration algorithm to dispatch decoding tasks according to the number of code blocks and the number of available turbo decoders at a given time. According to certain aspects, the turbo decoder scheduler may include an auxiliary module referred to as an output agent that provides storage for decoded information while waiting for other related code blocks to be completely decoded, as described further below.

A processor 270 periodically determines which pre-coding matrix to use. Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights, and then processes the extracted message.

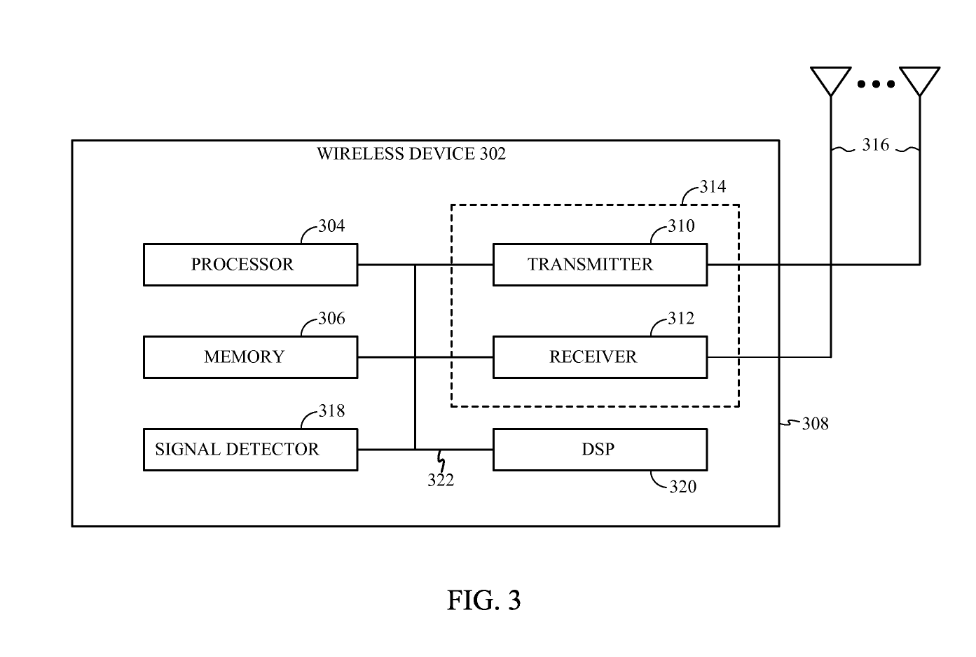

FIG. 3 illustrates various components that may be utilized in a wireless device 302 that may be employed within the wireless communication system illustrated in FIG. 1. The wireless device 302 is an example of a device that may be configured to implement the various methods described herein. The wireless device 302 may be a base station 100 or any of user terminals 116 and 122.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

According to certain aspects, the receiver 312 of the wireless device 302 may be configured to receive a plurality of code blocks of a first transport block. The receiver 312 may provide the plurality of code blocks to the DSP 320 via the bus system 322. According to certain aspects, the DSP 320 may be configured to schedule the plurality of code blocks to be decoded in a parallel with a plurality of channel decoders. Each channel decoder may be configured to decode at least one code block as a separate independent task. According to certain aspects, the DSP 320 may be further configured to collect output data from the plurality of decoders (i.e., decoded bits) and forward the collected decoded information bits for further processing, as described in detail below.

In one aspect of the present disclosure, logical wireless communication channels may be classified into control channels and traffic channels. Logical control channels may comprise a Broadcast Control Channel (BCCH) which is a downlink (DL) channel for broadcasting system control information. A Paging Control Channel (PCCH) is a DL logical control channel that transfers paging information. A Multicast Control Channel (MCCH) is a point-to-multipoint DL logical control channel used for transmitting Multimedia Broadcast and Multicast Service (MBMS) scheduling and control information for one or several Multicast Traffic Channels (MTCHs). Generally, after establishing Radio Resource Control (RRC) connection, the MCCH may be only used by user terminals that receive MBMS. A Dedicated Control Channel (DCCH) is a point-to-point bi-directional logical control channel that transmits dedicated control information and it is used by user terminals having an RRC connection. Logical traffic channels may comprise a Dedicated Traffic Channel (DTCH) which is a point-to-point bi-directional channel dedicated to one user terminal for transferring user information. Furthermore, logical traffic channels may comprise a Multicast Traffic Channel (MTCH), which is a point-to-multipoint DL channel for transmitting traffic data.

Transport channels may be classified into DL and UL channels. DL transport channels may comprise a Broadcast Channel (BCH), a Downlink Shared Data Channel (DL-SDCH) and a Paging Channel (PCH). The PCH may be utilized for supporting power saving at the user terminal (i.e., Discontinuous Reception (DRX) cycle may be indicated to the user terminal by the network), broadcasted over entire cell and mapped to physical layer (PHY) resources which can be used for other control/traffic channels. The UL transport channels may comprise a Random Access Channel (RACH), a Request Channel (REQCH), an Uplink Shared Data Channel (UL-SDCH) and a plurality of PHY channels.

The PHY channels may comprise a set of DL channels and UL channels. The DL PHY channels may comprise:

### Common Pilot Channel (CPICH),

### Synchronization Channel (SCH),

### Common Control Channel (CCCH),

### Shared DL Control Channel (SDCCH),

### Multicast Control Channel (MCCH),

### Shared UL Assignment Channel (SUACH),

### Acknowledgement Channel (ACKCH),

### DL Physical Shared Data Channel (DL-PSDCH),

### UL Power Control Channel (UPCCH),

### Paging Indicator Channel (PICH), and

### Load Indicator Channel (LICH).

The UL PHY Channels may comprise:

### Physical Random Access Channel (PRACH),

### Channel Quality Indicator Channel (CQICH),

### Acknowledgement Channel (ACKCH),

### Antenna Subset Indicator Channel (ASICH),

### Shared Request Channel (SREQCH),

### UL Physical Shared Data Channel (UL-PSDCH), and

### Broadband Pilot Channel (BPICH).

For the purposes of the present disclosure, the following abbreviations apply:

### ACK Acknowledgement

### AM Acknowledged Mode

### AMD Acknowledged Mode Data

### ARQ Automatic Repeat Request

### BCCH Broadcast Control CHannel

### BCH Broadcast CHannel

### BW Bandwidth

### C- Control-

### CB Contention-Based

### CCE Control Channel Element

### CCCH Common Control CHannel

### CCH Control CHannel

### CCTrCH Coded Composite Transport Channel

### CDM Code Division Multiplexing

### CF Contention-Free

### CP Cyclic Prefix

### CQI Channel Quality Indicator

### CRC Cyclic Redundancy Check

### CRS Common Reference Signal

### CTCH Common Traffic CHannel

### DCCH Dedicated Control CHannel

### DCH Dedicated CHannel

### DCI Downlink Control Information

### DL DownLink

### DRS Dedicated Reference Signal

### DSCH Downlink Shared Channel

### DSP Digital Signal Processor

### DTCH Dedicated Traffic CHannel

### E-CID Enhanced Cell IDentification

### EPS Evolved Packet System

FACH Forward link Access CHannel

### FDD Frequency Division Duplex

### FDM Frequency Division Multiplexing

### FSTD Frequency Switched Transmit Diversity

### HARQ Hybrid Automatic Repeat/request

### HW Hardware

### IC Interference Cancellation

L1 Layer 1 (physical layer)
L2 Layer 2 (data link layer)
L3 Layer 3 (network layer)

### LI Length Indicator

### LLR Log-Likelihood Ratio

### LSB Least Significant Bit

### MAC Medium Access Control

### MBMS Multimedia Broadcast Multicast Service

MCCH MBMS point-to-multipoint Control Channel

### MMSE Minimum Mean Squared Error

### MRW Move Receiving Window

### MSB Most Significant Bit

MSCH MBMS point-to-multipoint Scheduling CHannel
MTCH MBMS point-to-multipoint Traffic CHannel

### NACK Non-Acknowledgement

### PA Power Amplifier

### PBCH Physical Broadcast CHannel

### PCCH Paging Control CHannel

### PCH Paging CHannel

### PCI Physical Cell Identifier

### PDCCH Physical Downlink Control CHannel

### PDU Protocol Data Unit

### PHICH Physical HARQ Indicator CHannel

PHY PHYsical layer

### PhyCH Physical CHannels

### PMI Precoding Matrix Indicator

### PRACH Physical Random Access Channel

### PSS Primary Synchronization Signal

### PUCCH Physical Uplink Control CHannel

### PUSCH Physical Uplink Shared CHannel

### QoS Quality of Service

### RACH Random Access CHannel

### RB Resource Block

### RLC Radio Link Control

### RRC Radio Resource Control

### RE Resource Element

### RI Rank Indicator

### RNTI Radio Network Temporary Identifier

### RS Reference Signal

### RTT Round Trip Time

### Rx Receive

### SAP Service Access Point

### SDU Service Data Unit

### SFBC Space Frequency Block Code

SHCCH SHared channel decodingControl CHannel

### Scalable Scheduler Architecture for Channel Decoding

Due to limitations in throughput, conventional decoder architectures may not be able to satisfy the LTE throughput requirement with a single turbo decoder. As a result, certain aspects of the present disclosure provide a turbo decoder scheduler architecture to perform decoding in parallel. One challenge addressed by such an architecture comes from the dependency of adjunct process tasks. Based on the frame structure of LTE, the minimal time slot is defined as transmission time interval (TTI) which carries one transport block per layer. Each transport block has up to 15 code blocks. The processing unit of a turbo decoder is one code block; however, the logical output is based on one transport block. To speed up turbo decoding and enable parallel processing, the provided turbo decoder scheduler breaks the dependency between code blocks, decodes each as an individual task, and collects the decoded information bits of the same transport block from the plurality of turbo decoders.

According to certain aspects of the present disclosure, a turbo decoder scheduler may be able to fully utilize variable number of turbo decoders. It is also able break the dependency of neighboring decoding tasks, assign tasks to any available turbo decoder, and collect decoded bits concurrently. A centralized resource manager is created. The information of all available hardware resources including deinterleaver, turbo decoder and decoder output buffer is monitored in a centralized scoreboard. A turbo decoder scheduler will receive and dispatch decoding tasks depending on the availability of each resource. An arbitration algorithm is utilized to dispatch decoding tasks according to the variable number of turbo decoders.

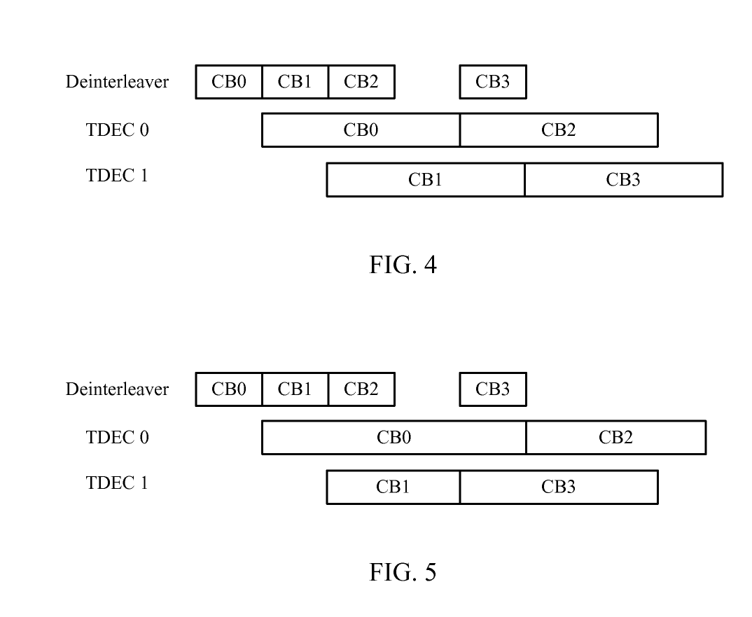

FIG. 4 illustrates one example of sequential completion of decoded code blocks by a deinterleaver and two turbo decoders (identified as “TDEC 0” and “TDEC 1”). The deinterleaver separates a symbol stream into a plurality of code blocks, identified as “CB0”, “CB1”, “CB2”, and “CB3”. A turbo decoder scheduler assigns each of the code blocks to the turbo decoders TDEC0 and TDEC1 as the turbo decoders complete their decoding task and become available. As shown in FIG. 4, each code block takes approximately an equal amount of time (i.e., processing cycles) to decode, and as such, the code blocks are completed in sequential order. However, the number of processing cycles needed for each code block is not necessarily uniform, which may lead to out-of-order completion of code blocks, as seen in FIG. 5.

FIG. 5 illustrates an example of out-of-order completion of decoded code blocks, where a later code block assigned for decoding completes decoding before previously assigned code blocks. Similar to the example shown in FIG. 4, a deinterleaver separates a symbol stream into a plurality of code blocks, identified as “CB0”, “CB1”, “CB2”, and “CB3”. Each of the code blocks are assigned to the turbo decoders TDEC0 and TDEC1 as the turbo decoders complete a decoding task and become available. As illustrated, the code block CB0 takes a longer time to decode than code block CB1 such that CB0 finishes decoding after the code block CB1 completes decoding despite being assigned before CB1. In this situation, the turbo decoder scheduler does not wait for the completion of code block CB0, but rather, dispatches code block CB2 to a first available turbo decoder, or turbo decoder TDEC1 in this example. Generally, due to out-of-order decoding, a turbo decoder that is processing the last decoding tasks of a transport block may hold until all previous code blocks of a transport block are completed. However, this behavior may lead to degradation of decoding efficiency as turbo decoders lay un-utilized for periods of time. In order to improve throughput efficiency, the turbo decoder scheduler may include an output agent module to temporarily store decoded information. After an output agent stores a decoded bit, turbo decoders may begin processing the next decoding task, thereby reducing time spent stalling. The turbo decoder scheduler may be configured to wait for the completion of the last code block of a transport block before pushing decoded bits to Level 1 (“L1”) or Level 2 (“L2”) software.

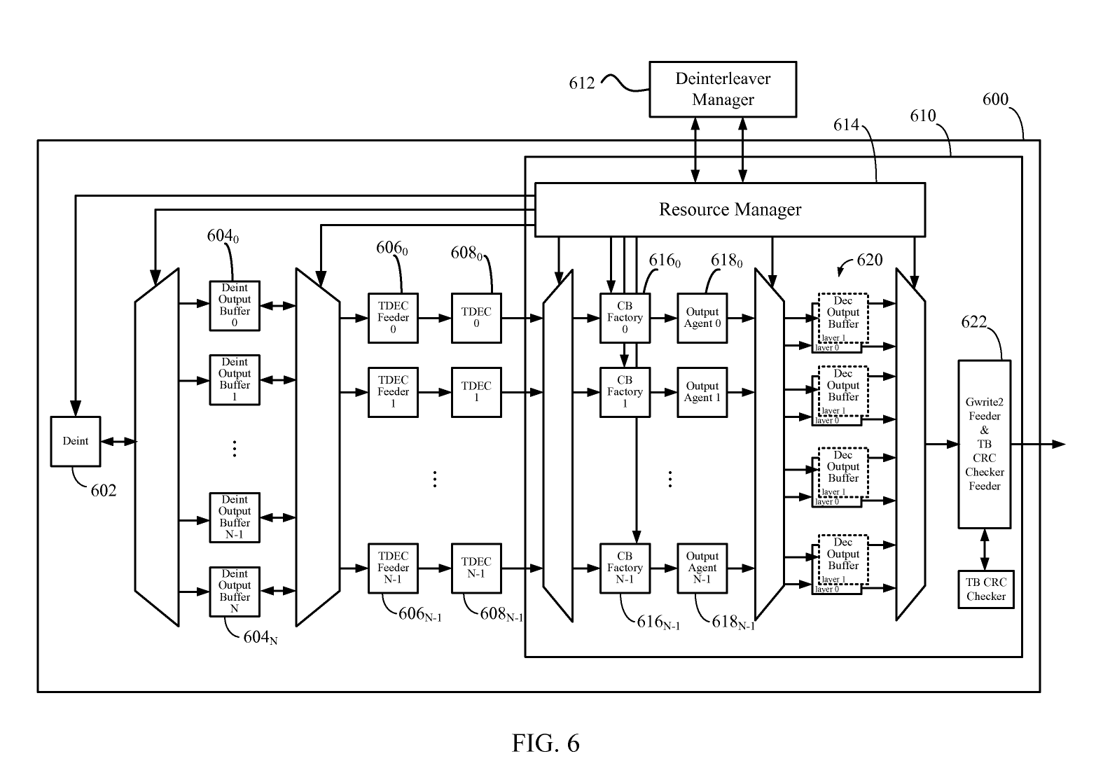

FIG. 6 is a schematic block diagram of a receiver processing system 600 configured to utilize a scalable scheduler architecture according to certain aspects of the present disclosure. The receiver processing system 600 includes a deinterleaver 602, which is configured to accept a received symbol stream and deinterleave (i.e., separates) the symbol stream into a plurality of code blocks for processing. As illustrated, the deinterleaver 602 provides the plurality of code blocks to a plurality of deinterleaver output buffers 604₀ . . . 604_{N} the temporarily store the plurality of code blocks prior to an assignment to a corresponding turbo decoder. As illustrated, the deinterleaver output buffers 604₀ . . . 604_{N} provide code blocks to a plurality of turbo decoders 608₀ . . . 608_{N-1} for processing and decoding. According to certain aspects, each of the plurality of turbo decoders 608₀ . . . 608_{N-1} is configured to perform a turbo decoding procedure on the provided code block and produce decoded information as output. It is noted that the number of deinterleaver output buffers 604₀ . . . 604_{N} (i.e., N) is one more than that of turbo decoders 608 . . . 608_{N-1} (i.e., N−1) because concurrently one deinterleaver writes to a deinterleaver output buffer and the turbo decoder feeders 606 read data from the deinterleaver output buffers 604. It is understood that the number of deinterleaver output buffers 604₀ . . . 604_{N}, turbo decoders 608₀ . . . 608_{N-1}, and turbo decoder output buffers 620 may be configured by a generic constant. According to certain aspects, the number of decoder output buffers 620 is one more than the number of turbo decoders 608 (i.e., N_{TDEC}+1).

As illustrated, the plurality of turbo decoders 608₀ . . . 608_{N-1} provide the decoded information to a turbo decoder scheduler 610. According to certain aspects, the turbo decoder scheduler 610 may be configured to receive transport block parameters and code block task parameters from a deinterleaver manager 612 inside a soft symbol processor (SSP), sends linked list random access memory (LLR) memory request to an LLR address generator and receives LLR samples for deinterleaving, provides the LLR samples to the deinterleaver for deinterleaving, coordinates turbo decoding of each code block, and sends the decoded payload bits along with predefined header bits back to L1/L2 software. The turbo decoder scheduler 610 generally fully utilizes all available turbo decoders by assigning the code blocks of the same transport block to different turbo decoders. According to certain aspects of the present disclosure, the turbo decoder scheduler 610 provides support for scheduling of a scalable number of turbo decoders. The turbo decoder scheduler 610 also provides support for variable code block sizes, such as code block sizes of about 40 to about 6,144 bits. According to one aspect, the turbo decoder scheduler 610 further provides support for storing decoded payload bits of two subframes and support for pushing decoding results of every transport block. According to certain aspects, the turbo decoder scheduler 610 provides support for 50 Mbit/s throughput in one field programmable gate array (FPGA).

As illustrated, the turbo decoder scheduler 610 generally includes a resource manager 614, a plurality of code block (CB) factories 616₀ . . . 616_{N-1}, a plurality of output agents 618₀ . . . 618_{N-1}, and a plurality of decoder output buffers 620. The turbo decoder scheduler 610 further includes a single gwrite2 feeder instance 622. Generally, the resource manager 614 handles incoming task assignments from the deinterleaver manager 612 and find available resources to process these assignments. According to certain aspects, the CB factories 616 allocate a decoder output buffer 620, request an available turbo decoder 608, and perform turbo decoding. The output agents 618₀ . . . 618_{N-1} store information of the last code block of the current transport block being processed, wait for all other code blocks to be finished, and enable the gwrite2 output feeder 622. The gwrite2 feeder 622 reads header and payload bits from the decoder output buffers 620 and calculate a transport block checksum.

Because the final output of the processing system 600 is the payload of a transport block but the processing unit of a CB factory 616 is a code block, and in order to break the dependency of consecutive code blocks, the resource manager 614 uses an “internal scoreboard” to store information from each code block. According to certain aspects, the resource manager 614 monitors several types of resources including the deinterleaver 602, deinterleaver output buffers 604₀ . . . 604_{N}, turbo decoders 608₀ . . . 608_{N-1}, turbo decoder feeders 606₀ . . . 606_{N-1}, CB factories 616₀ . . . 616_{N-1} (i.e. CB processing), decoder output buffers 620, and output feeder. In one specific example, the resource manager 614 may keep track of beginning and ending addresses of decoded payload bits inside a decoder output buffer 620 (i.e., CB starting and ending address), the number of code blocks in a given transport block (i.e, current CB index), the number of finished code blocks of a given transport block, and transport block parameters. The resource manager 614 selects deinterleaver output buffers 604₀ . . . 604_{N} based on a fixed priority scheme to select the first available one. Similarly, the resource manager 614 may also select available turbo decoders 608₀ . . . 608_{N-1} and turbo decoder feeders 606₀ . . . 606_{N-1} also based on a fixed priority scheme.

In operation, the turbo decoder scheduler 610 first performs a process of deinterleaver management by selecting an available deinterleaver output buffer 604 and initiating the deinterleaver 602 According to certain aspects, the turbo decoder scheduler 610 may act upon receiving transport block task parameters and code block task parameters. When a valid code block task parameter is received, the turbo decoder scheduler 610 may first check if a corresponding transport block task parameter is already received. According to certain aspects, the turbo decoder scheduler 610 may parse the received code block task parameters to determine a CB index and send the CB index to a quadratic permutation polynomial (QPP) look-up table to check if a corresponding transport block task parameter is already received. The turbo decoder scheduler 610 may then select an available deinterleaver output buffer 604, calculate its beginning address and ending address in the deinterleaver output buffer 604 and then initiate the deinterleaver 602 to start a deinterleaver process. After a code block is deinterleaved, the code block's task parameters, addresses, and index of its deinterleaver output buffer 604 will be stored into a task first-in first-out (FIFO) list until a CB factory 616 is ready to perform turbo decoding.

According to a certain aspects of the present disclosure, the transport block parameters include a parameters-valid parameter, a parameters-ready parameter, a transport block index, a transport block empty parameters, a transport block last flag, an assignment ID, a layer ID, a subframe count parameter, a harq count parameter, and a destination address parameter. The transport block valid parameter generally indicates whether the corresponding transport block parameters are present for the turbo decoder scheduler 610. The transport block parameters-ready parameter indicates the readiness of the turbo decoder scheduler 610 to accept an incoming task. The transport block index indicates an index of the current transport block. The transport-empty parameter indicates whether the current task is a dummy task which may be useful for interrupt generations. The transport block last flag indicates that the transport block is the last transport block of the current subframe. The assignment ID and layer ID indicate the assignment and layer index of the current PUSCH assignment. The subframe count and HARQ count parameter indicates the subframe count and HARQ count of the current PUSCH assignment, starting from zero. The destination address parameter indicates the destination address of pushing decoded payload bits and headers.

According to certain aspects of the present disclosure, the code block parameters include a code block parameters-valid flag, a code-block parameters-ready flag, a code block ID, a code block last flag, a code block sequential indexing number, a code block index size, and a code block filler bytes size. The code block parameters valid flag indicates that the corresponding code block parameters are present for the turbo decoder scheduler 610. The code block parameters-ready flag indicates that turbo decoder scheduler 610 has accepted the code block task parameters. After reset, this flag indicates the readiness of the turbo decoder scheduler 610 to accept an incoming code block task. The code block ID indicates which transport block the incoming code block belongs to. The code block last flag indicates whether the incoming code block is the last code block of the current transport block. The code block size index indicates the size index of the incoming code block, having a range from 0 to 187. The code block filler bytes size indicates the size of the filter bytes in the incoming code blocks.

According to certain aspects, when a code block is deinterleaved and ready for turbo decoding, the turbo decoder scheduler 610 may further perform a process of CB factory management by selecting and sending code block parameters to an available CB factory 616. In one specific example, the turbo decoder scheduler 610 may read code block task parameters from the task FIFO list and dispatch code block task parameters, transport block task parameters, and starting and ending addresses in a deinterleaver output buffer 604 to a first available CB factory 616. It is understood that each CB factory 616 may parse transport block task parameters to determine transport-block-specific information, such as a subframe count, a hybrid acknowledge repeat request (HARQ) count, and assignment ID.

Generally, each CB factory 616 is configured to allocate an available turbo decoder 608 and output buffer 620, read deinterleaved LLR samples from the deinterleaver output buffer 604 and send them to the allocated turbo decoder 608. Each CB factory 616 is further configured to receive decoded bits (i.e., hard decision bits) from the allocated turbo decoder 608 and store them in the decoder output buffer 620 according to the starting and ending address of the designated code block. After decoding of a current code block is done, each CB factory 616 will also prepare a CB header. If the current code block is the last code block of the current transport block, the CB factory 616 will generate transport block (TB) header and begin to clean up any unused CB header memory locations and pass parameters of the current code block to an available output agent 618.

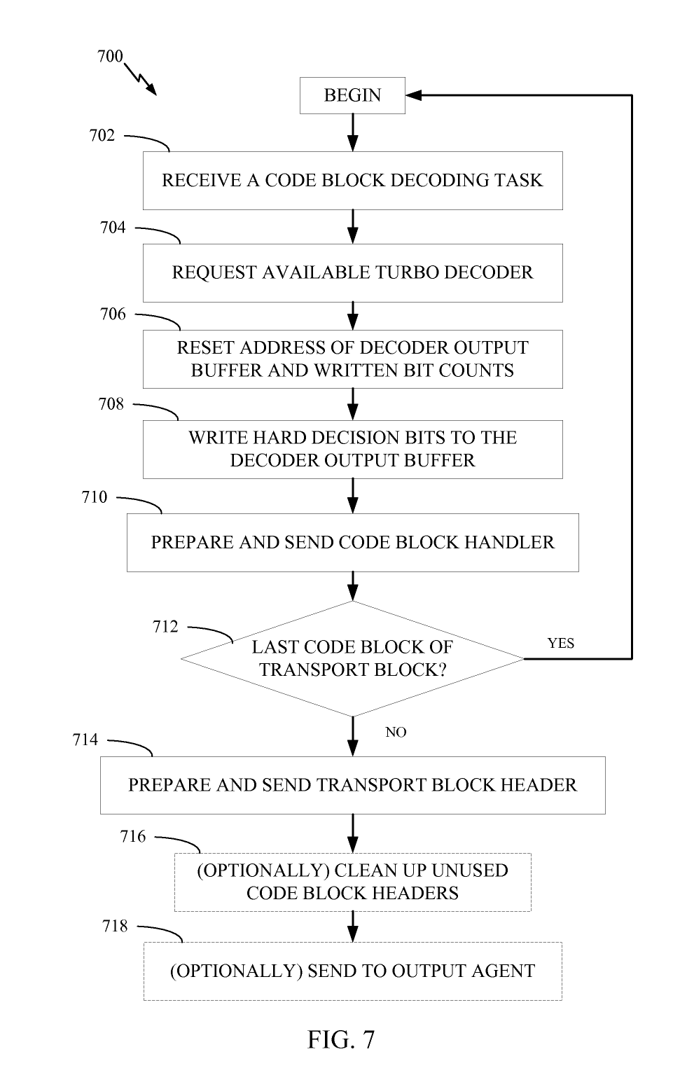

FIG. 7 illustrates example operations that may be performed by a CB factory 616 as directed by a turbo decoder scheduler 610. According to certain aspects, the operations begin at 702, where the CB factory 616 receives a code block decoding task. At 704, the CB factory 616 requests an available turbo decoder from a plurality of turbo decoders 608₀ . . . 608_{N-1}. At 706, the CB factory 616 resets the addresses of the decoder output buffer 620 and resets the count of bits already written. At 708, the CB factory 616 receives decoded bits (i.e., hard decision bits) from the requested turbo decoder 608 and writes the bits to the assigned decoder output buffer. At 710, the CB factory 616 prepares and sends the code block header. At 712, the CB factory 616 determines whether the decoded code block is the last code block of the given transport block. If not, it repeats the process 700. If so, the CB factory 616 prepares and sends a transport block header for the entire transport block. At 716, if the CB factory 616 is a component of an eNodeB implementation, the CB factory 616 optionally cleans up the unused code block headers. At 718, the CB factory 616 sends the output to an available output agent, if necessary.

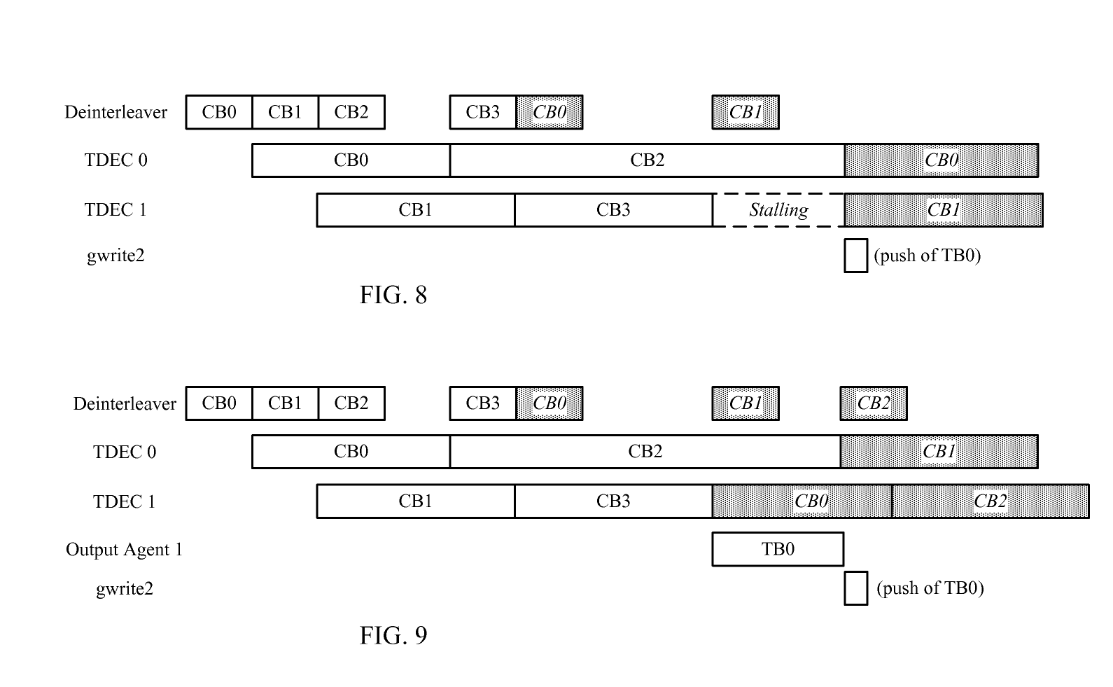

According to certain aspects of the present disclosure, the output agents 618 store information of a last code block of the transport block currently being processed while waiting for all other code blocks in the transport block to be finished. Due to out-of-order code block completion, as illustrated in FIG. 8 and discussed in detail below, the last code block of a transport block may finish earlier than its previous code blocks. Without an output agent 618, a corresponding CB factory 616 has to hold all related CB parameters until all previous code blocks are finished. As such, the use of the output agent 618 releases the CB factory 616 as well as the turbo decoder 608 right after decoding is finished. As a result, the CB factory 616 may resume operations and begin a new decoding task without having to stall or wait.

FIG. 8 depicts example operations of two turbo decoders (“TDEC 0” and “TDEC 1”) on four code blocks (“CB0”, “CB1”, “CB2”, “CB3”) of a transport block (“TB0”). As shown, a deinterleaver 602 separate a transport block into code blocks CB0, CB1, CB2, CB3. The code blocks are assigned to turbo decoder TDEC0 and TDEC1 as the turbo decoders become available. Assuming code block CB2 requires additional processing iterations and finishes decoding after CB1, turbo decoder TDEC1, which is processing the last code block CB3 of the first transport block, must wait until code block CB2 is finished before the turbo decoder TDEC1 can push the payload bits and a gwrite2 feeder 622 can push the entire transport bock TB0. This wait results in stalling.

FIG. 9 depicts similar example operations of the two turbo decoders of FIG. 8 with the addition of an output agent (“Output Agent 1”). As shown, the output agent 618 stores decoded bits and other information of transport block TB0 while waiting for the completion of the decoding of code block CB2. As shown, turbo decoder TDEC1 may begin to decode a first code block CB1 of another transport block TB1 because an output agent 618 is involved to wait for the completion of code block CB2 of the first transport block TB0

According to certain aspects of the disclosure, gwrite2 output feeder 622 is responsible for retrieving code block and transport block headers and payload bits from decoder output buffers 620, calculating transport block checksums (i.e., CRC) and sending both headers and decoded payload bits to a gwrite2 instance. Upon completion, gwrite2 output feeder 62 may generate a “transport block done” indication to signal an end of a transport block process. It is understood that an implementation of the output feeder 622 on an eNodeB may different from an implementation on an UE due to different header definition and payload format.

After a code block is done decoding, a CB factory 616 may generate a “code block done” signal. The resource manager 614 may accumulate occurrences of the “code block done” signal to determine whether all other code blocks of a given transport block are finished. If the resource manager 614 determines that all code blocks of a given transport block have been properly decoded, the resource manager 614 may clear a “finished transport block” task parameter to indicate that the resource manager 614 is ready to accept a next transport block task parameter.

Because turbo decoding is not a linear process, the cycle count to complete a code block cannot be formulated by a linear equation. The required cycle counts vary under different scenarios. For example, when the window size is 64, the corresponding code block size is 6,144, and the number of max iteration is 7.5; the adopted turbo decoder takes 25,828 cycles to finish one code block. Given a 75 Mhz clock rate and the fact that the turbo decoder scheduler 610 is able to assign the code blocks of the same transport block to all available turbo decoders, and assuming that there is no stalling from deinterleaver, the maximum throughput may be calculated as follows:

$$\begin{matrix}throughput = {N}_{TDEC} \times 6144 ( bit ) \times 75 Mhz \times \frac{1}{25828 ( cycles )} \\ = 17.84 {N}_{TDEC} ( Mbits \text{/} s )\end{matrix}$$

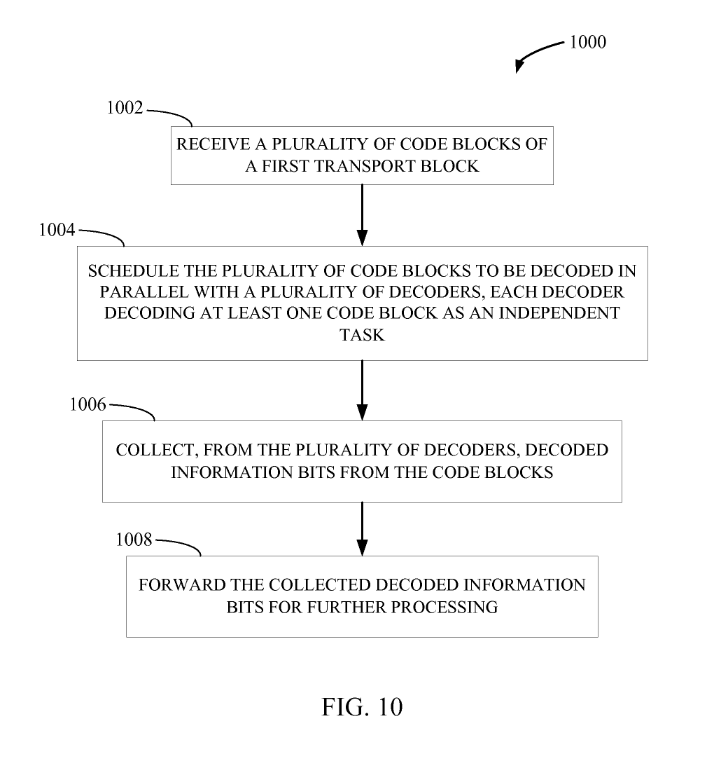

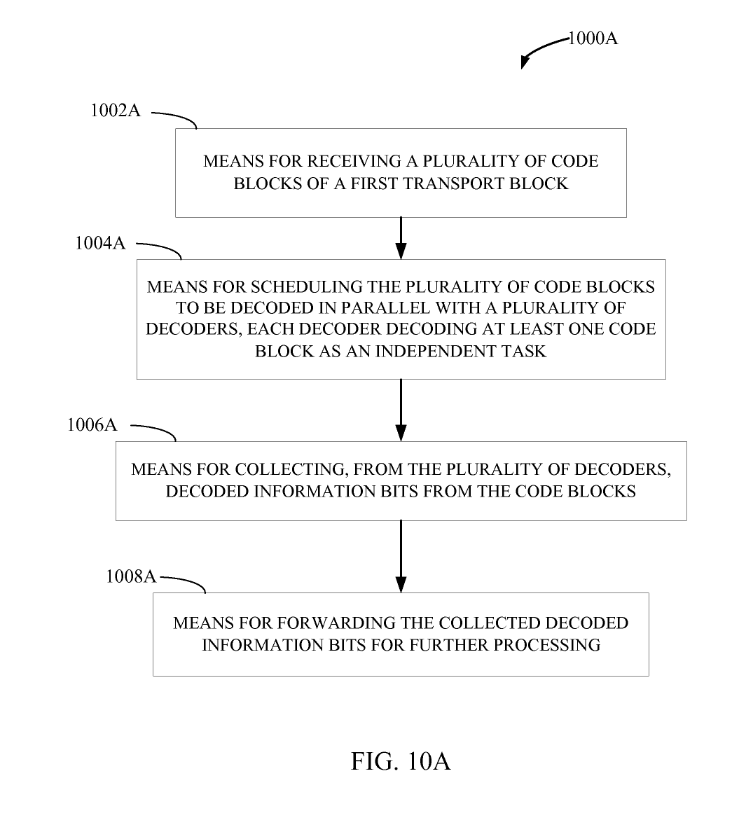

FIG. 10 illustrates example operations 1000 that may be performed, for example, by a receiver unit (e.g., at a base station or user equipment) utilizing a decoder architecture in accordance with certain aspects of the present disclosure. FIGS. 2, 3, and 6 illustrate example components that may be capable of performing the operations shown in FIG. 10. At 1002, the receiver unit receives a plurality of code blocks of a transport block. At 1004, the receiver unit schedules the plurality of code blocks to be decoded in parallel with a plurality of decoders, each decoder decoding at least one code block as an independent task. At 1006, the receiver unit collects, from the plurality of decoders, decoded information bits from the code blocks. At 1008, the receiver unit forwards the collected decoded information bits for further processing (e.g., to upper-layer L2/L3 software).

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, blocks 1002-1008 illustrated in FIG. 10 correspond to means-plus-function blocks 1002A-1008A illustrated in FIG. 10A.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. A method for wireless communications, comprising:
receiving a plurality of code blocks of a first transport block;
scheduling the plurality of code blocks to be decoded in parallel with a plurality of decoders, each decoder decoding at least one code block as an independent task;
collecting, from the plurality of decoders, decoded information bits from the code blocks; and
forwarding the collected decoded information bits for further processing.

2. The method of claim 1, further comprising:
monitoring availability of decoding resources; and
wherein the scheduling comprises dispatching decoding tasks based on the monitored availability.

3. The method of claim 2, wherein monitoring availability of decoding resources comprises monitoring availability of one or more deinterleavers, one or more turbo decoders, and one or more decoder output buffers.

4. The method of claim 2, further comprising:
stalling operations of one or more decoders, based on the monitored availability of decoding resources.

5. The method of claim 2, wherein the scheduling comprises:
scheduling processing of one or more code blocks of a second transport block to begin using one or more of the decoders before processing of one or more code blocks of the first transport block is completed.

6. The method of claim 5, further comprising:
storing the decoded information bits of some of the code blocks of the first transport block in an output agent while processing the remainder of the code blocks of the first transport block.

7. An apparatus for wireless communications, comprising:
logic for receiving a plurality of code blocks of a transport block;
logic for scheduling the plurality of code blocks to be decoded in parallel with a plurality of decoders, each decoder decoding at least one code block as an independent task;
logic for collecting, from the plurality of decoders, decoded information bits from the code blocks; and
logic for forwarding the collected decoded information bits for further processing.

8. The apparatus of claim 7, further comprising:
logic for monitoring availability of decoding resources; and
wherein the logic for scheduling comprises logic for dispatching decoding tasks based on the monitored availability.

9. The apparatus of claim 8, wherein logic for monitoring availability of decoding resources comprises logic for monitoring availability of one or more deinterleavers, one or more turbo decoders, and one or more decoder output buffers.

10. The apparatus of claim 8, further comprising:
logic for stalling operations of one or more decoders, based on the monitored availability of decoding resources.

11. The apparatus of claim 8, wherein the logic for scheduling comprises:
logic for scheduling processing of one or more code blocks of a second transport block to begin using one or more of the decoders before processing of one or more code blocks of a first transport block is completed.

12. The apparatus of claim 11, further comprising:
logic for storing the decoded information bits of some of the code blocks of the first transport block in an output agent while processing the remainder of the code blocks of the first transport block.

13. An apparatus for wireless communications, comprising:
means for receiving a plurality of code blocks of a transport block;
means for scheduling the plurality of code blocks to be decoded in parallel with a plurality of decoders, each decoder decoding at least one code block as an independent task;
means for collecting, from the plurality of decoders, decoded information bits from the code blocks; and
means for forwarding the collected decoded information bits for further processing.

14. The apparatus of claim 13, further comprising:
means for monitoring availability of decoding resources; and
wherein the means for scheduling comprise means for dispatching decoding tasks based on the monitored availability.

15. The apparatus of claim 14, wherein monitoring availability of decoding resources comprises monitoring availability of one or more deinterleavers, one or more turbo decoders, and one or more decoder output buffers.

16. The apparatus of claim 14, further comprising:
means for stalling operations of one or more decoders, based on the monitored availability of decoding resources.

17. The apparatus of claim 14, wherein the means for scheduling comprises:
means for scheduling processing of one or more code blocks of a second transport block to begin using one or more of the decoders before processing of one or more code blocks of a first transport block is completed.

18. The apparatus of claim 17, further comprising:
means for storing the decoded information bits of some of the code blocks of the first transport block in an output agent while processing the remainder of the code blocks of the first transport block.

19. A computer-program product for wireless communications, comprising a computer readable medium having instructions stored thereon, the instructions being executable by one or more processors and the instructions comprising:
instructions for receiving a plurality of code blocks of a transport block;
instructions for scheduling the plurality of code blocks to be decoded in parallel with a plurality of decoders, each decoder decoding at least one code block as an independent task;
instructions for collecting, from the plurality of decoders, decoded information bits from the code blocks; and
instructions for forwarding the collected decoded information bits for further processing.

20. The computer-program product of claim 19, wherein the instructions further comprise:
instructions for monitoring availability of decoding resources; and
wherein the scheduling comprises dispatching decoding tasks based on the monitored availability.

21. The computer-program product of claim 20, wherein the instructions for monitoring availability of decoding resources comprise instructions for monitoring availability of one or more deinterleavers, one or more turbo decoders, and one or more decoder output buffers.

22. The computer-program product of claim 20, wherein the instructions further comprise:
instructions for stalling operations of one or more decoders, based on the monitored availability of decoding resources.

23. The computer-program product of claim 20, wherein the instructions for scheduling comprises:
instructions for scheduling processing of one or more code blocks of a second transport block to begin using one or more of the decoders before processing of one or more code blocks of a first transport block is completed.

24. The computer-program product of claim 23, wherein the instructions further comprise:
instructions for storing the decoded information bits of some of the code blocks of the first transport block in an output agent while processing the remainder of the code blocks of the first transport block.

25. An apparatus for wireless communications, comprising:
at least one processor configured to:
receive a plurality of code blocks of a transport block;
schedule the plurality of code blocks to be decoded in parallel with a plurality of decoders, each decoder decoding at least one code block as an independent task;
collect, from the plurality of decoders, decoded information bits from the code blocks; and
forward the collected decoded information bits for further processing; and
a memory coupled to the at least one processor.

26. The apparatus of claim 25, wherein the processor is further configured to:
monitor availability of decoding resources; and
wherein the processor configured to schedule is further configured to dispatch decoding tasks based on the monitored availability.

27. The apparatus of claim 26, wherein the processor configured to monitor is further configured to monitor availability of one or more deinterleavers, one or more turbo decoders, and one or more decoder output buffers.

28. The apparatus of claim 26, wherein the processor is further configured to:
stall operations of one or more decoders, based on the monitored availability of decoding resources.

29. The apparatus of claim 26, wherein the at least one processor is configured to schedule processing of one or more code blocks of a second transport block to begin using one or more of the decoders before processing of one or more code blocks of a first transport block is completed.

30. The apparatus of claim 29, wherein the at least one processor is further configured to:
store the decoded information bits of some of the code blocks of the first transport block in an output agent while processing the remainder of the code blocks of the first transport block.
